(19) United States
(12) Patent Application Publication
(10) Pub. No.: US 2019/0390593 A1
(43) Pub. Date: Dec. 26, 2019

(54) Control System For A Heat Exchanger

(71) Applicant: GM GLOBAL TECHNOLOGY OPERATIONS LLC, Detroit, MI (US)

(72) Inventors: Bin Li, Troy, MI (US); Lawrence P. Ziehr, Clarkston, MI (US)

(21) Appl. No.: 16/014,270

(22) Filed: Jun. 21, 2018

(51) Int. Cl. F02B 29/04; F28F 27/00; F03G 7/06

(52) U.S. Cl. CPC F02B 29/0493; F28F 27/00; F02B 37/00; F28F 2255/04; F03G 7/065

(57) ABSTRACT

An assembly includes a heat exchanger with an inlet portion. an outlet portion, and at least one fluid passage fluidly coupling the inlet portion to the outlet portion. The assembly additionally includes a movable blocker element having a first position with respect to the heat exchanger and a second position with respect to the heat exchanger. In the second position the blocker element reduces cross-sectional area of the at least one fluid passage relative to the first position. The assembly further includes a passive actuator coupled to the blocker element and configured to selectively move the blocker element from the first position to the second position in response to a thermal condition being satisfied.

### TECHNICAL FIELD

The present disclosure relates to heat exchangers, and more specifically to a charge air cooler for an internal combustion engine assembly equipped with a supercharging device.

### INTRODUCTION

Internal combustion engines (ICE) are often called upon to generate considerable levels of power for prolonged periods of time on a dependable basis. Many ICE assemblies employ a mechanical supercharging device, such as a turbocharger, to compress the incoming airflow before it enters the intake manifold of the engine in order to increase power and efficiency. Specifically, a turbocharger is a gas compressor that forces more air and, thus, more oxygen into the combustion chambers of the ICE than is otherwise achievable with ambient atmospheric pressure (e.g., naturally-aspirated engines). The additional mass of oxygen-containing air that is forced into the ICE improves the engine's volumetric efficiency, allowing it to burn more fuel in a given cycle, and thereby produce more power.

Under extreme operating conditions, the “supercharging” process may elevate the temperature of the intake air to an extent that causes formation of undesired exhaust by-products, such as various nitrogen oxides (NOx), and reduces the density of the air charge. To combat this problem, original equipment manufacturers have historically employed a device most commonly known as an intercooler, but more appropriately identified as a charge air cooler (CAC) or aftercooler, to extract heat from the air exiting the supercharging device. A CAC is a heat exchange device used to cool the air charge and, thus, further improve volumetric efficiency of the ICE by increasing intake air charge density through isochoric cooling. A decrease in air intake temperature provides a denser intake charge to the engine and allows more air and fuel to be combusted per engine cycle, increasing the output of the engine.

The heat exchange process can cause moisture to condense and, thus, form inside of the CAC system, especially when conducted in conditions where the ambient air flowing through the supercharging device and CAC is substantially humid (e.g., greater than 50% relative humidity). The condensation tends to accumulate downstream from the CAC, within the conduit through which the intake manifold receives the supercharged airflow. The liquefied condensation can be drawn into the intake manifold, entering the various cylinder combustion chambers. Depending upon the configuration of the CAC and supercharging devices, as well as their individual and relative packaging, the condensation may begin to puddle and enter the combustion chambers in large amounts. The unintended introduction of condensate buildup to the engine cylinders can potentially cause the ICE to misfire, leading to premature engine wear, and creating a false-positive error signal triggering a service engine indicator light. In addition, accumulated water condensate that is not properly evacuated from the CAC can freeze and crack the CAC when ambient temperatures reach below freezing.

### SUMMARY

An assembly according to the present disclosure includes a heat exchanger with an inlet portion, an outlet portion, and at least one fluid passage fluidly coupling the inlet portion to the outlet portion. The assembly additionally includes a movable blocker element having a first position with respect to the heat exchanger and a second position with respect to the heat exchanger. In the second position the blocker element reduces cross-sectional area of the at least one fluid passage relative to the first position. The assembly further includes a passive actuator coupled to the blocker element and configured to selectively move the blocker element from the first position to the second position in response to a thermal condition being satisfied.

In an exemplary embodiment, the passive actuator comprises a shape memory material having an actuation end and a thermal sensing end.

In an exemplary embodiment, the heat exchanger further has an upstream fluid tank, a downstream fluid tank, and at least one fluid tube fluidly coupling the upstream fluid tank to the downstream fluid tank. In such embodiments, the fluid tube extends generally orthogonal to the fluid passage and is configured to exchange heat with the fluid passage. The passive actuator is provided with a thermal sensor disposed in the downstream fluid tank.

In an exemplary embodiment, the heat exchanger further has an upstream fluid tank, a downstream fluid tank, and at least one fluid tube fluidly coupling the upstream fluid tank to the downstream fluid tank. In such embodiments, the fluid tube extends generally orthogonal to the fluid passage and is configured to exchange heat with the fluid passage. The passive actuator is provided with a thermal sensor disposed in a fluid tube of the at least one fluid tube.

In an exemplary embodiment, the passive actuator is provided with a thermal sensor disposed external to the heat exchanger.

In an exemplary embodiment, the movable blocker element includes a grille slidably coupled to the heat exchanger. The grille is provided with at least one slot therethrough. In the first position the at least one slot is generally in register with the at least one fluid passage, and in the second position the at least one slot is not generally in register with the at least one fluid passage. In such embodiments, the inlet portion may define an inlet plane, and the grille may be configured to slide between the first and second positions generally parallel to the inlet plane.

In an exemplary embodiment, the movable blocker element includes a shutter assembly provided with a plurality of movable shutters, with the shutters being open in the first position and closed in the second position.

In an exemplary embodiment, the heat exchanger is a charge air cooler of a turbocharger for an internal combustion engine.

An internal combustion engine assembly according to the present disclosure includes an intake manifold, a supercharger having a compressor, and a charge air cooler having a core with a plurality of cooling tubes fluidly coupling the compressor to the intake manifold. The core additionally includes a plurality of cooling passages in thermal communication with the plurality of cooling tubes. The assembly also includes a blocker member movably coupled to the core. The blocker member is movable between a first position with respect to the plurality of cooling passages and a second position with respect to the plurality of cooling passages. In the second position the blocker member inhibits air flow through the plurality of cooling passages relative to the first position. The assembly further includes a passive actuator coupled to the blocker member and configured to selectively move the blocker member from the first position to the second position in response to a thermal condition being satisfied.

In an exemplary embodiment, the passive actuator comprises a shape memory material having an actuation end and a thermal sensing end. According to various embodiments, the thermal sensing end may be disposed in a respective cooling tube of the plurality of cooling tubes, external to the core, or in a downstream fluid tank fluidly coupling the plurality of cooling tubes to the intake manifold. In such embodiments, the movable blocker element may include a grille slidably coupled to the core and operably coupled to the actuation end, with the grille being provided with a plurality of slots therethrough. In the first position respective slots of the plurality of slots are generally in register with corresponding respective cooling passages of the plurality of cooling passages, and in the second position the respective slots are not generally in register with corresponding respective cooling passages. The plurality of cooling passages may have respective inlets defining an inlet plane, and the grille may be configured to slide between the first and second positions generally parallel to the inlet plane. In such embodiments, the movable blocker element may include a shutter assembly provided with a plurality of movable shutters operably coupled to the actuation end, with the shutters being open in the first position and closed in the second position.

Embodiments according to the present disclosure provide a number of advantages. For example, the present disclosure provides a system and method for passively controlling fluid flow through a heat exchanger to prevent overcooling and thereby mitigate the risk of ice forming in the heat exchanger.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of an internal combustion assembly according to an embodiment of the present disclosure;

FIG. 2 is a front view of a heat exchanger assembly according to a first embodiment of the present disclosure;

FIGS. 3A and 3B are cross-section views along line 3-3 in FIG. 2 in first and second operation modes;

FIG. 4 a front view of a heat exchanger assembly according to a second embodiment of the present disclosure;

FIG. 5 is a front view of a heat exchanger assembly according to a third embodiment of the present disclosure; and

FIG. 6 is a schematic representation of a shutter assembly for a heat exchanger according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

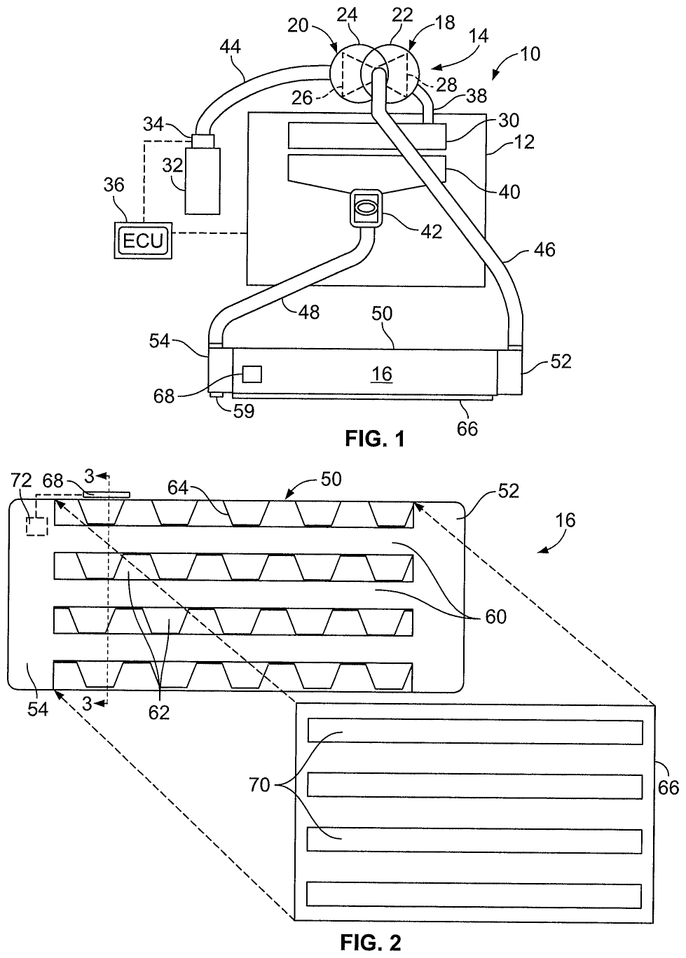

Referring now to FIGS. 1 through 3, a schematic illustration of a representative internal combustion engine (ICE) assembly is shown and identified generally as 10, with which the present invention may be incorporated and practiced. It should be readily understood that FIG. 1 is merely an exemplary application by which the present invention may be utilized. As such, the present invention is by no means limited to the particular engine configuration of FIG. 1. In addition, although the ICE assembly 10 is intended for use in an automobile, such as, but not limited to, standard passenger cars, sport utility vehicles, light trucks, heavy duty vehicles, minivans, and the like, it may be incorporated into any motorized vehicle application, including, but certainly not limited to, buses, tractors, boats and personal watercraft, airplanes, etc. Finally, the drawings presented herein are not to scale, and are provided purely for instructional purposes. As such, the specific and relative dimensions shown in the drawings are not to be considered limiting.

The ICE assembly 10 includes an engine block (also referred to in the art as “cylinder case”) and a cylinder head, which are represented collectively at 12. The ICE assembly 10 is equipped with a supercharging device, represented herein by a turbocharger device 14, and a charge air cooler (CAC) 16. Notably, the engine block and cylinder head 12, turbocharger device 14, and CAC 16 shown in FIG. 1 hereof have been greatly simplified, it being understood that further information regarding the function and operation of such systems may be found in the prior art. In addition, those skilled in the art will recognize that the engine block and cylinder head 12 may be integrally formed (as depicted in FIG. 1), or be pre-fabricated as individual, separate components that are subsequently connected to one another, e.g., by bolting, welding, or other attachment means. Finally, the ICE assembly 10 may operate in a compression-ignited or spark-ignited combustion mode within the scope of the invention claimed herein.

With continued reference to FIG. 1, the ICE assembly 10 includes an exhaust manifold 30 (also referred to in the art as “exhaust header”) that is fluidly coupled to the engine block and cylinder head 12, and configured to receive and expel exhaust gases therefrom. For example, the cylinder case portion of the engine block and cylinder head 12 defines a plurality of exhaust ports (not shown) through which exhaust gases or products of combustion are selectively evacuated from a plurality of variable-volume combustion chambers (not shown) fluidly coupled therewith. The exhaust ports communicate the exhaust gases to the exhaust manifold 30, which may be defined within the cylinder head portion of the engine block and cylinder head 12. The exhaust manifold 30 delivers a portion of the exhaust gas to the turbocharger device 14, and a portion to an exhaust aftertreatment system (not illustrated herein) for reducing the toxicity of the exhaust gas emissions before subsequent release to the atmosphere.

The ICE assembly 10 also includes an air intake system, which is represented herein by an intake manifold 40 (or inlet manifold) in downstream fluid communication with a throttle body 42. The throttle body 42 is operable to regulate the amount of air flowing into the engine, normally in response to driver input. The intake manifold 40, on the other hand, is responsible for evenly distributing the fuel/air mixture to the intake port(s) (not shown) of the various variable volume combustion chambers.

Operation of the ICE assembly 10 creates a pressure gradient when the engine is in an on-state. For example, the downward movement of the reciprocating pistons (not shown) inside each variable volume combustion chamber, along with the fluid restriction caused by the throttle valve (not shown) inside the throttle body 42 (referred to as “choked flow”) creates a vacuum inside the intake manifold 40.

The turbocharger device 14 is in fluid communication with the air intake system of the ICE assembly 10, operable to compress the incoming air charge before it enters the intake manifold 40. More specifically, the turbocharger device 14 includes a turbine portion 18 and a compressor portion 20. The turbine portion 18 has a turbine housing 22, which is fluidly coupled to the exhaust manifold 30 via exhaust line 38. The turbine housing 22 redirects a portion of the flowing exhaust stream from the exhaust manifold 30 to spin a turbine blade or impeller, shown hidden in FIG. 1 at 28, rotatably mounted therein. The compressor portion 20, on the other hand, has a compressor housing 24 with a compressor blade, shown schematically in phantom at 26 in FIG. 1, rotatably mounted therein. Inlet air for the compressor housing 24 is drawn from the ambient atmosphere through a clean air filter 32 via clean air duct 44.

The turbine blade 28 is rigidly coupled to the compressor blade 26 (e.g., linked by a shared axle) for unitary rotation therewith, as seen in FIG. 1. During normal operation of the ICE assembly 10, the turbine housing 22 receives exhaust gases from the exhaust manifold 30, forcing the impeller 28 and, thus, the compressor blade 26 to rotate. As the compressor blade 26 spins, ambient air received from air filter 32 is compressed within the compressor housing 24. Air compressed by the compressor portion 20 is communicated by compressor output duct (or CAC inlet duct) 46 to the CAC system 16, the compressor housing 24 being in upstream fluid communication with the CAC 16. It should be recognized that the present invention may incorporate a single turbocharger, twin turbochargers, staged turbochargers, or various other engine supercharging devices without departing from the intended scope of the present invention.

Still referring to FIG. 1 of the drawings, a mass airflow (MAF) sensor 34 is positioned between the clean air filter 32 and clean air duct 44. The MAF sensor 34 is used to determine the mass of air entering the ICE assembly 10—i.e., through the compressor portion 20 of turbocharger device 14, and communicate this information to an engine control unit (ECU) 36. The air mass information is necessary for the ECU 36 to calculate and deliver the correct fuel mass to the intake manifold 40.

The charge air output is routed from the compressor portion 20 of the turbocharger device 14 through the CAC 16 before entering the intake manifold 40. To this regard, the CAC system 16 is fluidly coupled to the ICE air intake system, positioned in downstream fluid communication with the turbocharger device 14, and in upstream fluid communication with the air intake manifold 40 and throttle body 42. The CAC system 16 is configured to extract heat from compressed airflow exiting the turbocharger device 14—i.e., cool the air charge, prior to the compressed airflow entering the ICE air intake system.

The CAC system 16 includes a heat exchanger core assembly 50 with a first end tank 52 (also referred to herein as an “inlet end tank” or “upstream end tank”) operatively attached thereto. The upstream end tank 52 provides a transition to allow the intake air from the turbocharger device 14 to flow from the compressor output duct 46 into the inner cooling tubes 60 of the CAC 16. The upstream end tank 52 is in upstream fluid communication with a second end tank 54 (also referred to herein as the “outlet end tank” or “downstream end tank”) operatively attached to an opposite end of the heat exchanger core assembly 50. The downstream end tank 54 provides a transition to allow the intake air to flow from the cooling tubes 60 of the CAC system 16 to an induction duct 48, for subsequent transfer to the throttle body 42.

The heat exchanger core assembly 50 is provided with a plurality of cooling passages 62 disposed between the cooling tubes 60. The cooling passages 62 extend from a fore end of the heat exchanger core assembly 50 to an aft end of the heat exchange core assembly. The cooling passages 62 are provided with heat exchanger fins 64 in thermal communication with the cooling tubes 60. As fluid, e.g. ambient air, passes through the cooling passages 62, heat is transferred from the heat exchanger fins 64 to the fluid to thereby cool the cooling tubes 60 and, in turn, intake air in the cooling tubes 60.

When operating in cold conditions, condensate or ice may form inside the CAC system 16 as the air is further cooled by the heat exchanger core assembly 50. As noted above, the ICE assembly 10 creates a pressure gradient when in an on-state. “Engine misfire” is a phenomena that may occur when a threshold volume of water condensation builds up inside of a CAC, which is then ingested by the intake manifold in undesirable quantities due to the higher “suction” pressure created by the intake manifold. “Underboost” is a phenomena that may occur when a threshold volume of ice builds up inside of a CAC, which can cause excessive pressure drop within a CAC, and result in lower than desired boost pressure at throttle body inlet 42. The CAC system 16 may be provided with a drain port or other condensate extractor 59 to remove condensate from the CAC system 16; however, such condensate extractors may not be adequate to extract ice.

A blocker member 66 is movably coupled to the heat exchanger core assembly 50. The blocker member 66 is arranged to move among a plurality of positions with respect to the heat exchanger core assembly 50 selectively restrict fluid flow through the cooling passages 62. A passive actuator 68 is operatively coupled to the blocker member 66 and is configured to move the blocker member 66 among the plurality of positions in response to changes in temperature, as will be discussed in further detail below.

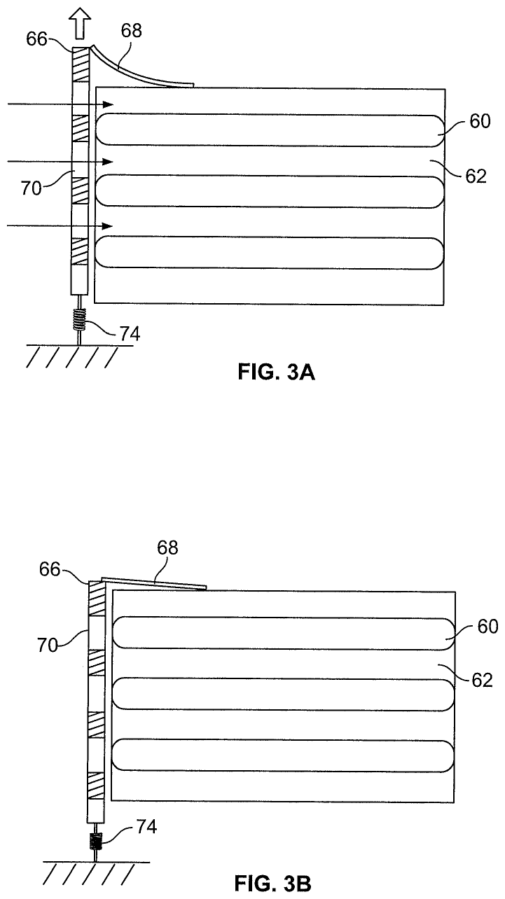

In the embodiment illustrated in FIGS. 2 and 3, the blocker member 66 comprises a movable grille coupled to the fore portion of the heat exchanger core 50. The grille is provided with a plurality of slots 70 extending therethrough. In an exemplary embodiment, the spacing between the slots 70 corresponds to spacing between the cooling tubes 60 of the heat exchanger core assembly 50. In other embodiments, the blocker member may be configured otherwise, e.g. coupled to the aft portion of the heat exchanger core 50. The grille may be slidably coupled to the heat exchanger core 50 by any suitable means, e.g. by sliding in a track coupled to the heat exchanger core 50.

In a first position, illustrated in FIG. 3A, the grille is positioned with the slots 70 generally in register with the cooling passages 62. Fluid, as illustrated by the arrows, may thereby pass through the cooling passages 62 to provide cooling to the cooling tubes 60.

The grille may be moved, e.g. translated in a direction generally perpendicular to the flow of fluid, to a second position, illustrated in FIG. 3B. In the second position, the grille is positioned with the slots 70 generally in register with the cooling tubes 60. Fluid is thereby restricted from passing through the cooling passages 62, reducing the cooling effect on the cooling tubes 60.

A passive actuator 68 is operatively coupled to the blocking member 66 and configured to move the blocking member 66 between the first position and the second position. The passive actuator 68 is provided with a temperature sensing element 72. In the embodiment illustrated in FIGS. 1-3, the temperature sensing element 72 is provided in the downstream end tank 54 to sense a temperature of intake air downstream of the heat exchanger core assembly 50. However, the sensing element 72 may be positioned in other locations, as will be discussed in further detail below.

In the illustrated embodiment, a spring member 74 is coupled to the blocking member 66 and configured to bias the blocking member 66 toward the first position. The spring member 74 may be secured to any suitable attachment point, e.g. a rigid portion of the heat exchanger core assembly 50.

In the illustrated embodiment, the passive actuator 68 and temperature sensing element 72 are both defied by a thermally-activatable shape memory element with a first end disposed in the downstream end tank 54, forming the temperature sensing element 72, and a second end coupled to the blocking member 66, forming the actuator 68. Suitable thermally active shape memory materials include, but are not limited to, shape memory alloys (SMAs), shape memory polymers (SMPs), and the like, as well as composite compositions comprising at least one of the foregoing shape memory materials. These shape memory materials generally have the ability to return to some previously defined shape or size when subjected to an appropriate thermal stimulus. Specifically, after being deformed pseudoplastically, SMAs can be restored to their original shape by heating them above a characteristic temperature.

In response to an increase in temperature at the temperature sensing element 72, the shape memory material of the actuator 68 returns to a previously defined shape and moves the blocker member 66 to the first position. Upon subsequent decreases in temperature, the shape memory material of the actuator 68 relaxes, and the blocking member 66 is returned to the second position by the spring member 74. The blocking member 66 is thereby passively controlled to restrict fluid flow through the cooling passages 62 when appropriate, thereby reducing the chance of overcooling intake air in the cooling tubes 60.

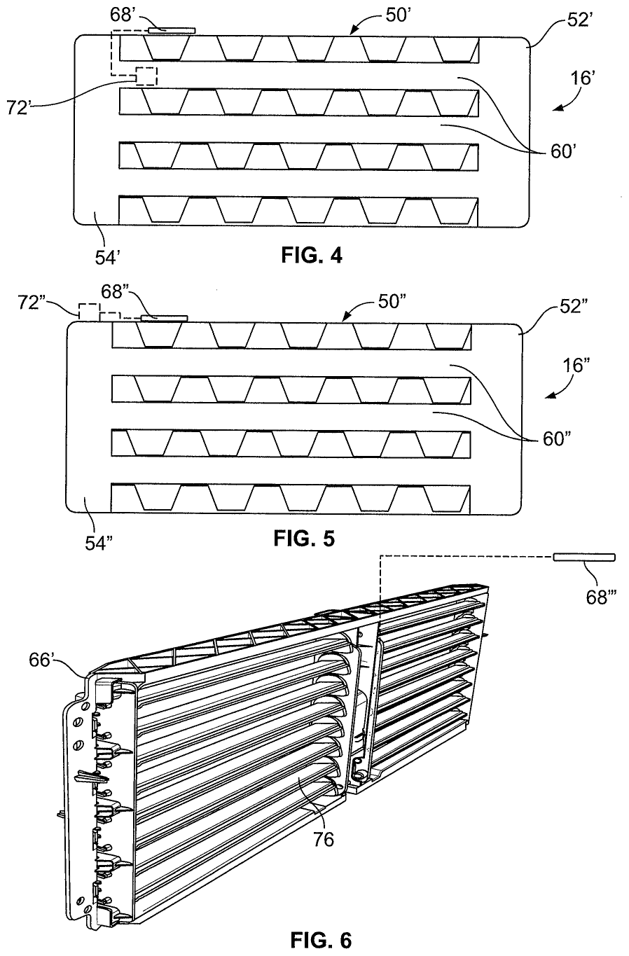

Referring now to FIG. 4, a first alternative embodiment is illustrated. In this embodiment, a CAC system 16′ includes a heat exchanger core assembly 50′ with an upstream end tank 52′ operatively attached thereto. The upstream end tank 52′ is in upstream fluid communication with a downstream end tank 54′ operatively attached to an opposite end of the heat exchanger core assembly 50′. A plurality of cooling tubes 60′ fluidly couple the upstream end tank 52′ to the downstream end tank 54′. The heat exchanger core assembly 50′ is provided with a passive actuator 68′ similar to the actuator 68 discussed above with respect to FIGS. 1-3. The actuator 68′ is provided with a temperature sensing element 72′ disposed in one of the cooling tubes 60′. The actuator 68′ may thereby passively control a blocking member as discussed above, responsive to changes in temperature in the cooling tubes 60′.

Referring now to FIG. 5, a second alternative embodiment is illustrated. In this embodiment, a CAC system 16″ includes a heat exchanger core assembly 50″ with an upstream end tank 52″ operatively attached thereto. The upstream end tank 52″ is in upstream fluid communication with a downstream end tank 54″ operatively attached to an opposite end of the heat exchanger core assembly 50″. A plurality of cooling tubes 60″ fluidly couple the upstream end tank 52″ to the downstream end tank 54″. The heat exchanger core assembly 50″ is provided with a passive actuator 68″ similar to the actuator 68 discussed above with respect to FIGS. 1-3. The actuator 68″ is provided with a temperature sensing element 72″ external to the heat exchanger core assembly 50″. The actuator 68″ may thereby passively control a blocking member as discussed above, responsive to changes in temperature of fluid external to the heat exchanger core assembly 50″, e.g. ambient air.

Referring now to FIG. 6, a further alternative embodiment is illustrated. In this embodiment, a blocker member 66′ comprises a shutter assembly having a plurality of shutters 76, movable between a plurality of positions. In this embodiment, a passive actuator 68′″ is operatively coupled to the shutter assembly and configured to move the shutters 76 among the plurality of positions responsive to changes in temperature. The passive actuator 68′″ is configured to move the shutters 76 to a closed position in response to decreases in temperature and to move the shutters 76 to an open position in response to increases in temperature. The passive actuator 68′″ may be configured in a generally similar fashion as discussed with respect to any of the foregoing embodiments.

In other embodiments, the movable blocker element may also take other forms of grille assemblies, or other geometries that are connected to the actuation end, positions of which can be controlled by the passive actuator to either allow cooling air or block cooling air to enter the heat exchanger.

Further variations are, of course, possible. As an example, other types of passive actuators, such as paraffin wax actuators, may be implemented in place of shape memory materials. Moreover, embodiments according to the present disclosure may be used to control heat exchange for other types of heat exchangers in automotive and non-automotive contexts, in addition to charge air coolers.

As may be seen the present disclosure provides a system for passively controlling fluid flow through a heat exchanger to prevent overcooling, and thereby mitigate the risk of ice forming in the heat exchanger.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An assembly comprising:
a heat exchanger comprising an inlet portion, an outlet portion, and at least one fluid passage fluidly coupling the inlet portion to the outlet portion;
a movable blocker element having a first position with respect to the heat exchanger and a second position with respect to the heat exchanger, wherein in the second position the blocker element reduces cross-sectional area of the at least one fluid passage relative to the first position; and
a passive actuator coupled to the blocker element and configured to selectively move the blocker element from the first position to the second position in response to a thermal condition being satisfied.

2. The assembly of claim 1, wherein the passive actuator comprises a shape memory material having an actuation end and a thermal sensing end.

3. The assembly of claim 1, wherein the heat exchanger further comprises an upstream fluid tank, a downstream fluid tank, and at least one fluid tube fluidly coupling the upstream fluid tank to the downstream fluid tank, the fluid tube extending generally orthogonal to the fluid passage and configured to exchange heat with the fluid passage, and wherein the passive actuator is provided with a thermal sensor disposed in the downstream fluid tank.

4. The assembly of claim 1, wherein the heat exchanger further comprises an upstream fluid tank, a downstream fluid tank, and at least one fluid tube fluidly coupling the upstream fluid tank to the downstream fluid tank, the fluid tube extending generally orthogonal to the fluid passage and configured to exchange heat with the fluid passage, and wherein the passive actuator is provided with a thermal sensor disposed in a fluid tube of the at least one fluid tube.

5. The assembly of claim 1, wherein the passive actuator is provided with a thermal sensor disposed external to the heat exchanger.

6. The assembly of claim 1, wherein the movable blocker element comprises a grille slidably coupled to the heat exchanger, the grille being provided with at least one slot therethrough, wherein in the first position the at least one slot is generally in register with the at least one fluid passage, and in the second position the at least one slot is not generally in register with the at least one fluid passage.

7. The assembly of claim 6, wherein the inlet portion defines an inlet plane, and wherein the grille is configured to slide between the first and second positions generally parallel to the inlet plane.

8. The assembly of claim 1, wherein the movable blocker element comprises a shutter assembly provided with a plurality of movable shutters, the shutters being open in the first position and closed in the second position.

9. The assembly of claim 1, wherein the heat exchanger is a charge air cooler of a turbocharger for an internal combustion engine.

10. An internal combustion engine assembly comprising:
an intake manifold;
a supercharger having a compressor;
a charge air cooler having a core with a plurality of cooling tubes fluidly coupling the compressor to the intake manifold and further including a plurality of cooling passages in thermal communication with the plurality of cooling tubes;
a blocker member movably coupled to the core, the blocker member being movable between a first position with respect to the plurality of cooling passages and a second position with respect to the plurality of cooling passages, wherein in the second position the blocker member inhibits air flow through the plurality of cooling passages relative to the first position; and
a passive actuator coupled to the blocker member and configured to selectively move the blocker member from the first position to the second position in response to a thermal condition being satisfied.

11. The internal combustion engine assembly of claim 10, wherein the passive actuator comprises a shape memory material having an actuation end and a thermal sensing end.

12. The internal combustion engine assembly of claim 11, wherein the charge air cooler further comprises an upstream fluid tank fluidly coupling the plurality of cooling tubes to the compressor and a downstream fluid tank fluidly coupling the plurality of cooling tubes to the intake manifold, the thermal sensing end being disposed in the downstream fluid tank.

13. The internal combustion engine assembly of claim 11, wherein the thermal sensing end is disposed in a respective cooling tube of the plurality of cooling tubes.

14. The internal combustion engine assembly of claim 11, wherein the thermal sensing end is disposed external to the core.

15. The internal combustion engine assembly of claim 11, wherein the blocker element comprises a grille slidably coupled to the core and operably coupled to the actuation end, the grille being provided with a plurality of slots therethrough, wherein in the first position respective slots of the plurality of slots are generally in register with corresponding respective cooling passages of the plurality of cooling passages, and in the second position the respective slots are not generally in register with corresponding respective cooling passages.

16. The internal combustion engine assembly of claim 15, wherein the plurality of cooling passages has respective inlets defining an inlet plane, and wherein the grille is configured to slide between the first and second positions generally parallel to the inlet plane.

17. The internal combustion engine assembly of claim 11, wherein the blocker element comprises a shutter assembly provided with a plurality of movable shutters operably coupled to the actuation end, the shutters being open in the first position and closed in the second position.
